(19) United States
(12) Patent Application Publication
(10) Pub. No.: US 2026/0023769 A1
(43) Pub. Date: Jan. 22, 2026

(54) METHOD FOR GENERATING ANSWER BASED ON ADVANCED RETRIEVAL AUGMENTED GENERATION AND SYSTEM THEREFOR

(71) Applicant: SAMSUNG SDS CO., LTD., Seoul (KR)

(72) Inventors: Jaehoon LEE, Seoul (KR); Sohyun KIM, Seoul (KR); Wanggeun PARK, Seoul (KR); Geon YI, Seoul (KR); Bongkeun SHIN, Seoul (KR)

(73) Assignee: SAMSUNG SDS CO., LTD., Seoul (KR)

(21) Appl. No.: 19/230,881

(22) Filed: Jun. 6, 2025

(30) Foreign Application Priority Data
Jul. 17, 2024 (KR) 10-2024-0094088
Oct. 30, 2024 (KR) 10-2024-0150594

(51) Int. Cl. G06F 16/334

(52) U.S. Cl. CPC G06F 16/3344

(57) ABSTRACT

The disclosure relates to a high-performance RAG-based answer generation method, which includes: acquiring a query; performing a first evaluation task based on the query using a pre-trained critique model; retrieving documents related to the query based on a result of the first evaluation task; performing a second evaluation task based on the query and the retrieved documents using the critique model; and generating one or more answers, based on the query and one or more related documents, using a large language model (LLM) according to a result of the second evaluation task.

### CROSS-REFERENCE TO RELATED APPLICATION(S)

This application claims priority to Korean Patent Application No. 10-2024-0094088 filed on Jul. 17, 2024 and Korean Patent Application No. 10-2024-0150594 filed on Oct. 30, 2024, in the Korean Intellectual Property Office, the entire contents of which are hereby incorporated by reference in its entirety.

### BACKGROUND OF THE INVENTION

### 1. Field of the invention

The disclosure relates to generative AI technology using retrieval-augmented generation (RAG) and, more specifically, to a method and system for retrieving documents related to a user's query and generating an answer corresponding to the user's query using the retrieved documents.

### 2. Description of the Prior Art

A large language model (LLM) is a large-scale deep learning model pretrained with a large amount of data to perform various natural language processing. Although an LLM exhibits excellent performance, it needs to solve problems such as hallucination, slow knowledge updating, and lack of answer transparency for practical use. Recently, retrieval-augmented generation (RAG) technology has been proposed to solve these problems.

Retrieval-augmented generation (RAG) is a technology for retrieving relevant information from a large set of documents before generating an answer to a user's query in the LLM model and generating an answer using the retrieved information. This RAG technology improves the accuracy of the answer and helps reduce hallucination of the LLM model, especially, in knowledge-intensive tasks. In addition, users can verify the accuracy of the answer by citing the source, which increases the trust in the output of the LLM model. In addition, it is easy to update knowledge and introduce knowledge in a specific field.

However, although the existing RAG-based generative AI system is cost-effective and has better performance than using only the LLM model, there are several problems.

First, the existing RAG-based generative AI system generates an answer to the user's query by always referring to search results thereof, so there is a problem that the search process is performed even when the search is unnecessary. This may lead to unnecessary resource consumption and time delay by using a search engine even for tasks such as questions where information does not change periodically, data analysis, translation, and creative writing.

Second, the existing RAG-based generative AI system has a limited function to evaluate the relevance between the query and the search result. Since the retrieved documents may not match the user's intention or may contain information with low relevance, inaccurate search results may degrade the quality of the finally generated answer.

Third, the existing RAG-based generative AI system has a problem that it does not sufficiently consider the groundedness between search results and LLM answers. As a result, the answer generated by the LLM model may not match the retrieved information or may contain incorrect information. This may make it difficult to provide reliable answers to users.

Lastly, the existing RAG-based generative AI system lacks the ability to systematically evaluate the groundedness between user queries and LLM answers. As a result, the answers provided by the LLM model may not match the user's intention, which may degrade the quality of the user experience.

Therefore, a solution is needed to solve the problems caused by the existing RAG-based generative AI system.

### SUMMARY OF THE INVENTION

The disclosure aims to solve the aforementioned problems and other problems. In one aspect of the disclosure, the disclosure is to provide a method and system for generating a critique model capable of performing evaluation tasks related to retrieval-augmented generation (RAG) based on a pretrained language model (PLM).

In another aspect of the disclosure, the disclosure is to provide a method and system for improving performance of the retrieval-augmented generation (RAG) by performing evaluation tasks related to the retrieval-augmented generation (RAG) based on a pretrained critique model.

According to one aspect of the disclosure, there is provided a high-performance RAG-based answer generation method including: acquiring a query; performing a first evaluation task based on the query using a pre-trained critique model; retrieving documents related to the query based on a result of the first evaluation task; performing a second evaluation task based on the query and the retrieved documents using the critique model; and generating one or more answers, based on the query and one or more related documents, using an LLM model according to a result of the second evaluation task.

According to another aspect of the disclosure, there is provided a device including: one or more processors configured to execute a plurality of operations for generating an answer based on retrieval-augmented generation (RAG); and one or more memories configured to store a plurality of instructions for executing the plurality of operations, and the plurality of operations may include: acquiring a query; performing a first evaluation task based on the query using a pre-trained critique model; retrieving documents related to the query based on a result of the first evaluation task; performing a second evaluation task based on the query and the retrieved documents using the critique model; and generating one or more answers, based on the query and one or more related documents, using a large language model (LLM) according to a result of the second evaluation task.

According to another aspect of the disclosure, there is provided a computer-readable storage medium storing one or more programs for generating an answer corresponding to a user query by one or more processors of a computing device, and the one or more programs may include instructions for: acquiring a query; performing a first evaluation task based on the query using a pre-trained critique model; retrieving documents related to the query based on a result of the first evaluation task; performing a second evaluation task based on the query and the retrieved documents using the critique model; and generating one or more answers, based on the query and one or more related documents, using a large language model (LLM) according to a result of the second evaluation task.

### BRIEF DESCRIPTION OF THE DRAWINGS

The attached drawings are included as part of the detailed description to help understanding of the disclosure and illustrate embodiments and technical features of the disclosure along with the detailed description.

FIG. 1 is a diagram illustrating the configuration of a high-performance RAG-based answer generation system according to an embodiment of the disclosure.

FIG. 2 is a diagram illustrating a method for performing a first RAG evaluation task in a RAG evaluation unit.

FIG. 3 is a diagram illustrating a method for performing a second RAG evaluation task in a RAG evaluation unit.

FIG. 4 is a diagram illustrating a method for performing a third RAG evaluation task in a RAG evaluation unit.

FIG. 5 is a diagram illustrating a method for performing a fourth RAG evaluation task in a RAG evaluation unit.

FIG. 6 is a flowchart illustrating a high-performance RAG-based answer generation method according to an embodiment of the disclosure.

FIG. 7 is a diagram illustrating the high-performance RAG-based answer generation method in FIG. 6.

FIG. 8 is a diagram illustrating the high-performance RAG-based answer generation method in FIG. 6.

FIG. 9 is a flowchart illustrating a critique model generation method according to an embodiment of the disclosure.

FIG. 10A is a diagram illustrating a method for constructing task-specific learning data.

FIG. 10B is a diagram illustrating a method for constructing task-specific learning data.

FIG. 11A is a diagram illustrating a method for constructing task-specific learning data.

FIG. 11B is a diagram illustrating a method for constructing task-specific learning data.

FIG. 12A is a diagram illustrating a method for constructing task-specific learning data.

FIG. 12B is a diagram illustrating a method for constructing task-specific learning data.

FIG. 13A is a diagram illustrating a method for constructing task-specific learning data.

FIG. 13B is a diagram illustrating a method for constructing task-specific learning data.

FIG. 14 is a diagram illustrating a method for fine-tuning a pretrained language model (PLM) based on task-specific learning data.

FIG. 15 is a block diagram of a computing device according to an embodiment of the disclosure.

### DETAILED DESCRIPTION OF THE EXEMPLARY EMBODIMENTS

Hereinafter, the embodiments disclosed in this specification will be described in detail with reference to the attached drawings. Regardless of the reference numerals, identical or similar elements will be assigned the same reference numerals, and redundant descriptions thereof will be omitted. The terms “module” and “unit” used for elements in the following description are assigned or used interchangeably only for the convenience of drafting the specification, and do not have distinct meanings or roles in themselves. That is, the term “unit” used in the disclosure indicates software or a hardware element such as FPGA or ASIC, and the “unit” performs a certain role. However, the “unit” is not limited to software or hardware. The “unit” may be configured to reside in an addressable storage medium or may be configured to reproduce one or more processors. Accordingly, as an example, “units” include elements such as software elements, object-oriented software elements, class elements, and task elements, processes, functions, properties, procedures, subroutines, segments of program code, drivers, firmware, microcode, circuits, data, databases, data structures, tables, arrays, and variables. The functions provided by the elements and “units” may be combined into a smaller number of elements and “units” or may be further divided into additional elements and “units”.

In addition, in describing the embodiments disclosed in this specification, a detailed description of a related known technology, which may obscure the subject matter of the embodiments disclosed in this specification, will be omitted.

In addition, the attached drawings are only intended to facilitate easy understanding of the embodiments disclosed in this specification, and the technical ideas disclosed in this specification are not limited to the attached drawings, and should be understood to include all modifications, equivalents, or substitutes included in the scope of the disclosure.

The disclosure proposes a method and system for generating a critique model capable of performing evaluation tasks related to retrieval-augmented generation (RAG) based on a pretrained language model (PLM). In addition, the disclosure proposes a method and system for improving the performance of retrieval-augmented generation (RAG) by performing evaluation tasks related to the retrieval-augmented generation (RAG) based on a pretrained critique model.

Hereinafter, various embodiments of the disclosure will be described in detail with reference to the drawings.

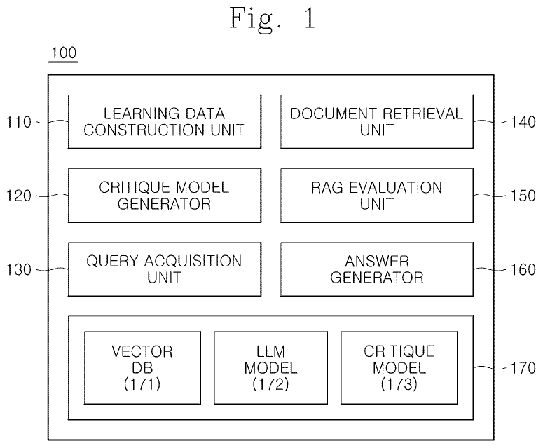

FIG. 1 is a diagram illustrating the configuration of a high-performance RAG-based answer generation system according to an embodiment of the disclosure.

Referring to FIG. 1, a high-performance RAG-based answer generation system 100 according to an embodiment of the disclosure may include a learning data construction unit 110, a critique model generator 120, a query acquisition unit 130, a document retrieval unit 140, a RAG evaluation unit 150, an answer generator 160, and a storage 170. The components illustrated in FIG. 1 are not essential for implementing a high-performance RAG-based answer generation system, so the high-performance RAG-based answer generation system described in this specification may have more or fewer components than the components listed above. The high-performance RAG-based answer generation system may be referred to as a high-performance RAG-based answer generation device.

The learning data construction unit 110 may construct learning data for generating a critique model. At this time, the learning data construction unit 110 may construct learning data for each evaluation task.

The critique model generator 120 may fine-tune a pretrained language model (PLM), based on the pre-built task-specific learning data, to generate a critique model. At this time, at least one of zero-shot learning, one-shot learning, and few-shot learning may be used as a method for fine-tuning the pretrained language model (PLM), but the disclosure is not necessarily limited thereto.

The query acquisition unit 130 may acquire user's query data from a user terminal (not shown). At this time, the query data may be configured in the form of text, image, or voice (audio).

The query acquisition unit 130 may provide the query data acquired from the user terminal to at least one of the document retrieval unit 140, the RAG evaluation unit 150, and the answer generator 160.

The document retrieval unit 140 may retrieve documents (passages) related to the user's query from a vector database 171. At this time, the document retrieval unit 140 may retrieve documents related to the query, based on the similarity between the user's query and documents in the vector database.

The document retrieval unit 140 may resort the ranks of the document retrieval (search) results using a re-ranker model. This is intended to resort the ranks of the initial search results and prioritize more relevant information at the top.

The document retrieval unit 140 may provide the resorted top K documents to at least one of the RAG evaluation unit 150 and the answer generator 160.

The RAG evaluation unit 150 may perform first to fourth RAG evaluation tasks using a pretrained critique model.

Here, the first RAG evaluation task is a task for evaluating whether to generate an answer with reference to the document retrieval results for the user query or to generate an answer directly without reference to the document retrieval results. The second RAG evaluation task is a task for evaluating the relevance between the user query and the retrieved document. The third RAG evaluation task is a task for evaluating the groundedness between the related document and the LLM answer. The fourth RAG evaluation task is a task for evaluating the utility score between the user query and the LLM answer. The first to fourth RAG evaluation tasks will be described in detail later.

Meanwhile, although this embodiment shows that four evaluation tasks are performed using one critique model, the disclosure is not necessarily limited thereto. Therefore, it will be obvious to those skilled in the art that a separate critique model may be constructed and used for each evaluation task.

The answer generator 160 may generate an answer corresponding to the user's query using an LLM model 172. At this time, the answer generator 160 may generate an answer with reference to the document retrieval results according to the execution of the first RAG evaluation task, or may generate an answer directly without reference to the document retrieval results.

In the case of referencing the document retrieval results, the answer generator 160 may generate a prompt including the user query and the document retrieval result, and input the generated prompt into the LLM model 172, thereby generating an answer to the user query.

At this time, the answer generator 160 may generate L answers with reference to the top L related documents, respectively, or may generate one answer by merge the top L related documents into one document.

In the former case, the answer generator 160 may calculate a critique score, based on the relevance score of the second RAG evaluation task, the groundedness score of the third RAG evaluation task, and the utility score of the fourth RAG evaluation task. The answer generator 160 may select the optimal answer, based on the generated critique score.

Meanwhile, in the case of not referencing the document retrieval results, the answer generator 160 may generate a prompt that includes only the user query and input the generated prompt into the LLM model 172, thereby generating an answer to the user query.

The storage 170 may include a vector database 171, an LLM model 172, and a critique model 173.

The vector database 171 may store embedding vectors for a plurality of documents related to the service domain.

The LLM model 172 is a very large deep learning model that has been pretrained with a large amount of data to perform various natural language processing. The LLM model 172 may be used to generate an answer to the user query. A commercial LLM model may be used as the LLM model 172.

The critique model 173 is a model that performs an evaluation task related to retrieval-augmented generation (RAG). The critique model 173 may be generated by fine-tuning a pretrained language model (PLM), based on pre-built task-specific learning data.

Meanwhile, although this embodiment describes the LLM model 172 and the critique model 173 being built inside the high-performance RAG-based answer generation system 100, the disclosure is not necessarily limited thereto. Therefore, it will be apparent to those skilled in the art that at least one of the LLM model 172 and the critique model 173 may be built through a separate external server depending on the embodiment of the disclosure.

As described above, the high-performance RAG-based answer generation system according to an embodiment of the disclosure may improve the performance of retrieval-augmented generation (RAG) by performing evaluation tasks related to the retrieval-augmented generation (RAG), based on a pretrained critique model. In addition, the high-performance RAG-based answer generation system may improve the accuracy of document retrieval and answer generation by improving the performance of retrieval-augmented generation (RAG), thereby increasing user satisfaction.

Hereinafter, the evaluation tasks performed by the RAG evaluation unit 150 will be described in more detail.

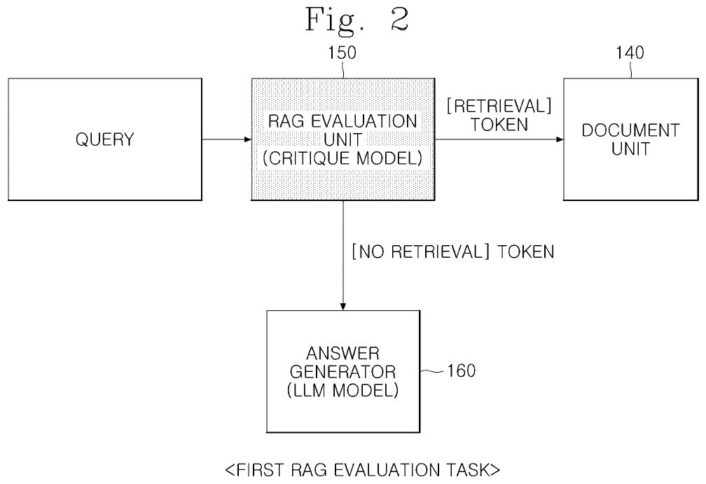

First, FIG. 2 is a diagram illustrating a method for performing a first RAG evaluation task in a RAG evaluation unit.

As shown in FIG. 2, the RAG evaluation unit 150 may perform a first RAG evaluation task using a pretrained critique model 173. Here, the first RAG evaluation task is a task for evaluating whether to generate an answer with reference to the document retrieval results for the user query or to generate an answer directly without reference to the document retrieval results.

The critique model 173 may determine whether to refer to the document retrieval results, based on input query data, and, based on the determination result, output either a [Retrieval] token or a [No Retrieval] token. Here, the [Retrieval] token instructs to generate an answer with reference to the document retrieval result, and the [No Retrieval] token instructs to generate an answer without the document retrieval result.

In the case where the critique model 173 outputs a [Retrieval] token, the RAG evaluation unit 150 may request the document retrieval unit 140 to retrieve documents. On the other hand, in the case where the critique model 173 outputs a [No Retrieval] token, the RAG evaluation unit 150 may request the answer generator 160 to generate an answer.

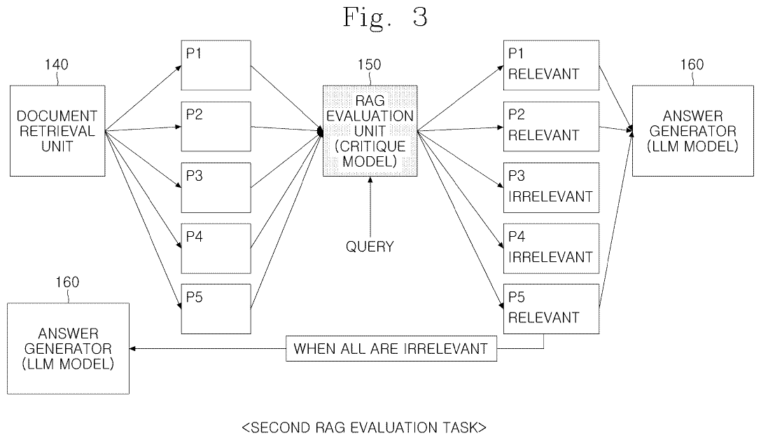

FIG. 3 is a diagram illustrating a method for performing a second RAG evaluation task in a RAG evaluation unit.

As illustrated in FIG. 3, the RAG evaluation unit 150 may perform a second RAG evaluation task using a pretrained critique model 173. Here, the second RAG evaluation task is a task for evaluating the relevance between a user query and a retrieved document.

The critique model 173 may determine the relevance between a user's query and retrieved documents, based on the input query data and the retrieved document data P1 to P5, and assign (allocate) either a [Relevant] token or an [Irrelevant] token to each retrieved document, based on the determination result. Here, the [Relevant] token indicates that there is relevance between the query and the retrieved document, and the [Irrelevant] token indicates that there is no relevance between the query and the retrieved document.

In the case where the critique model 173 assigns a [Relevant] token to at least one retrieved document, the RAG evaluation unit 150 may request the answer generator 160 to generate an answer based on the query and the related document. On the other hand, in the case where the critique model 173 assigns an [Irrelevant] token to all retrieved documents, the RAG evaluation unit 150 may request the answer generator 160 to generate an answer based on the query.

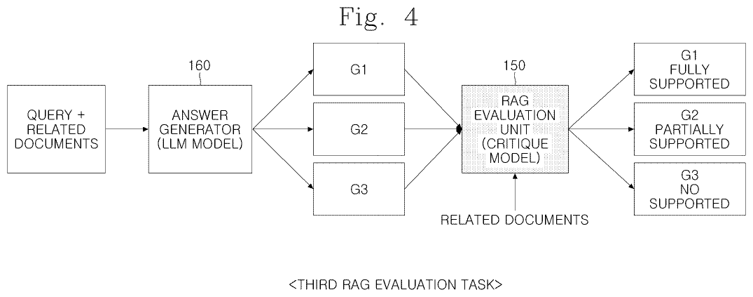

FIG. 4 is a diagram illustrating a method for performing a third RAG evaluation task in a RAG evaluation unit.

As illustrated in FIG. 4, the RAG evaluation unit 150 may perform a third RAG evaluation task using a pretrained critique model 173. Here, the third RAG evaluation task is a task for evaluating the groundedness between related documents and an LLM answer.

The critique model 173 may determine the groundedness between an LLM answer and related documents, based on input answer data G1, G2, and G3 and related document data P1, P2, and P5, and may assign one of a [Fully Supported] token, a [Partially Supported] token, and a [Not Supported] token to each answer, based on the determination result. Here, the [Fully Supported] token indicates that the LLM answer is sufficiently supported by the related document, the [Partially Supported] token indicates that the LLM answer is supported by part of the related document, and the [Not Supported] token indicates that the LLM answer is not supported by the related document.

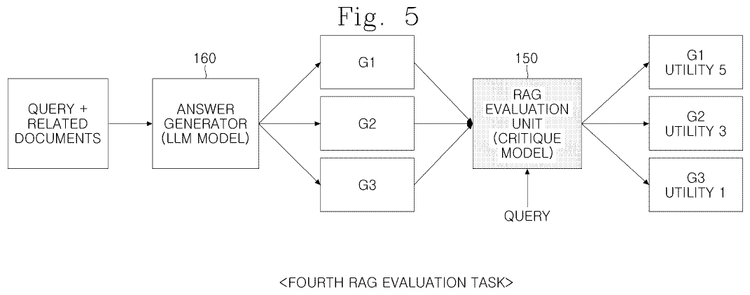

FIG. 5 is a diagram illustrating a method for performing a fourth RAG evaluation task in a RAG evaluation unit.

As illustrated in FIG. 5, the RAG evaluation unit 150 may perform a fourth RAG evaluation task using a pretrained critique model 173. Here, the fourth RAG evaluation task is a task for evaluating the utility score between a user query and an LLM answer.

The critique model 173 may determine the utility score between the user query and LLM answers, based on input query data and answer data G1, G2, and G3, and may assign one of a [Utility 1] token, a [Utility 2] token, a [Utility 3] token, a [Utility 4] token, and a [Utility 5] token to each answer, based on the determination result. At this time, the critique model 173 assigns the [Utility 1] token if the utility score between the query and the answer is the lowest, and assigns the [Utility 5] token if the utility score between the query and the answer is the highest. Although the utility scores are classified into 5 scores in this embodiment, they are not necessarily limited thereto.

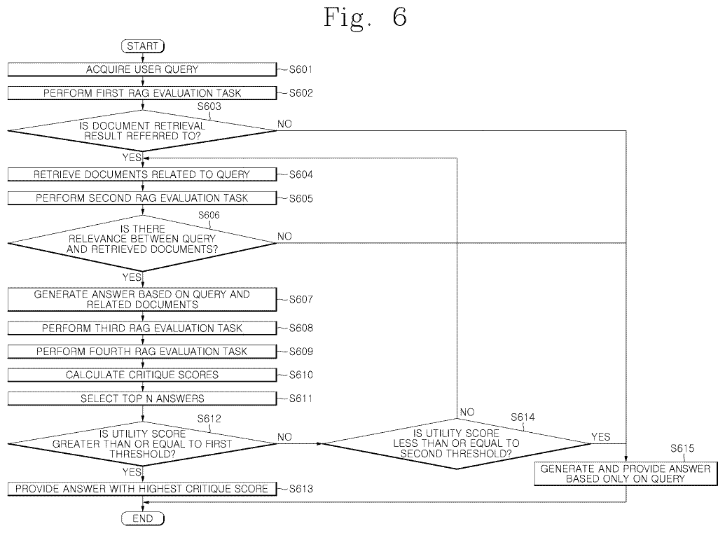

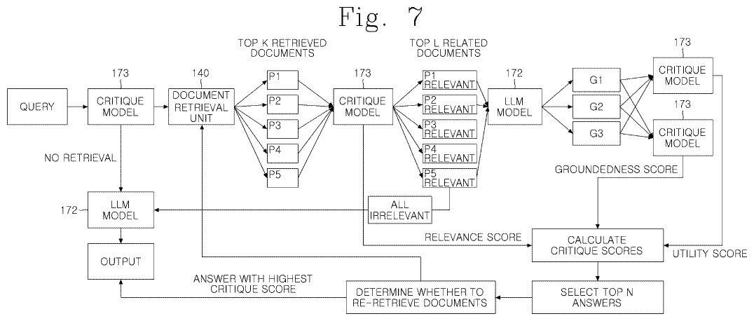

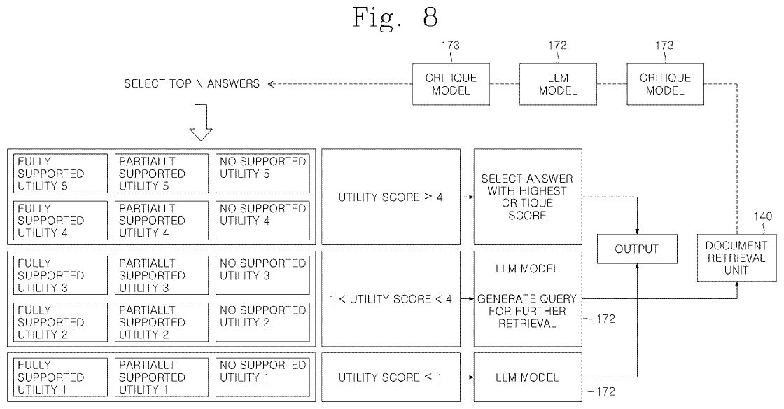

FIG. 6 is a flowchart illustrating a high-performance RAG-based answer generation method according to an embodiment of the disclosure, and FIGS. 7 and 8 are diagrams illustrating the high-performance RAG-based answer generation method in FIG. 6. The high-performance RAG-based answer generation method according to this embodiment may be performed by the high-performance RAG-based answer generation system 100. Although the high-performance RAG-based answer generation method is illustrated into multiple steps in the illustrated flowchart, at least some of the steps may be performed in a different order, combined with other steps and performed together, omitted, divided into sub-steps and performed, or performed by adding one or more steps that are not illustrated thereto.

Referring to FIGS. 6 to 8, the answer generation system 100 according to the disclosure may acquire user's query data from a user terminal (S601).

The answer generation system 100 may perform a first RAG evaluation task using a pretrained critique model 173 (S602). At this time, the answer generation system 100 may use a critique model 173 to determine whether to refer to a document retrieval result, based on the user query and, based on the determination result, output either a [Retrieval] token or a [No Retrieval] token.

In the case of not referring to the document retrieval result as a result of performing the first RAG evaluation task (S603), the answer generation system 100 may use an LLM model 172 to generate an answer based only on the user's query (S615).

On the other hand, in the case of referring to the document retrieval result as a result of performing the first

RAG evaluation task (S603), the answer generation system 100 may retrieve documents related to the user's query from a vector database 171 (S604). The answer generation system 100 may resort the ranks of the retrieved documents using a re-ranker model.

The answer generation system 100 may perform a second RAG evaluation task using the pretrained critique model 173 (S605). At this time, the answer generation system 100 may determine the relevance between the user's query and the retrieved documents using the critique model 173 and assign either a [Relevant] token or an [Irrelevant] token to each retrieved document, based on the determination result.

If there is no relevance between the user query and all retrieval documents as a result of performing the second RAG evaluation task (S606), the answer generation system 100 may generate an answer based only on the user's query using the LLM model 172 (S615).

On the other hand, if there is relevance between the user query and at least one retrieval document as a result of performing the second RAG evaluation task (S606), the answer generation system 100 may generate an answer, based on the user query and the related document, using the LLM model 172 (S607).

At this time, the answer generation system 100 may generate L answers with reference to the top L related documents, respectively, or may generate one answer by merging the top L related documents into one document. Hereinafter, in this embodiment, generating L answers with reference to each of the top L related documents will be described as an example.

The answer generation system 100 may perform a third RAG evaluation task using the pretrained critique model 173 (S608). At this time, the answer generation system 100 may use the critique model 173 to determine the groundedness between the related document and the LLM answers and, based on the determination result, assign one of a [Fully Supported] token, a [Partially Supported] token, and a [Not Supported] token to each answer.

The answer generation system 100 may perform a fourth RAG evaluation task using the pretrained critique model 173 (S609). At this time, the answer generation system 100 may use the critique model 173 to determine the groundedness between the user query and the LLM answers and, based on the determination result, assign one of a [Utility 1] token, a [Utility 2] token, a [Utility 3] token, a [Utility 4] token, and a [Utility 5] token to each answer.

The answer generation system 100 may calculate a critique score for each answer using the relevance score of the second RAG evaluation task, the groundedness score of the third RAG evaluation task, and the utility score of the fourth RAG evaluation task (S610).

For example, the answer generation system 100 may calculate a critique score using Equation 1 below.

$$Critique score = α \cdot ( relevance\_score * ( 1 - ( \frac{1}{{n}_{doc}} ) * ( rank - 1 ) ) ) + β \cdot groundedness\_score + γ \cdot utility\_score \qquad [ Equation 1 ]$$

Here, relevance_score is the relevance score of the second RAG evaluation task, groundedness_score is the groundedness score of the third RAG evaluation task, utility score is the utility score of the fourth RAG evaluation task,

$$( 1 - ( \frac{1}{{n}_{doc}} ) * ( rank - 1 ) )$$

is a ranking weight, n_{doc} is the number of retrieved documents, rank is the rank of the retrieved document, and α, β, γ are the weights for the scores.

The relevance score, the roundedness score, and the utility score are scores that normalize the occurrence probability of a critique token for each task.

First, the relevance score may be calculated using Equation 2 below.

$$relevance score = \frac{p ( relevance token ) = [ Relevant ]}{\begin{matrix}p ( relevance token ) = ⌈ Relevant ⌉ + \\ p ( relevance token ) = ⌈ Irrelevant ⌉\end{matrix}} \qquad [ Equation 2 ]$$

The groundedness score may be calculated using Equation 3 below.

$$groundedness score = \frac{p ( ground token ) = [ Fully ]}{S} + 0.5 * \frac{p ( ground token ) = [ Partially ]}{S} \qquad [ Equation 3 \}$$

Here, S=Σ_{r∈(Full, Partially, No)}p(ground token)=t.

The utility score may be calculated using Equation 4 below.

$$utility score = {\sum }_{i}^{5} {w}_{i} ( \frac{p ( utility token ) = i}{S} ) \qquad [ Equation 4 ]$$

Here, S=Σ_{r∈(1,2,3,4,5)}p(utility token)=t, and wᵢ is a weight.

The answer generation system 100 may select the top N answers from among L answers, based on the calculated critique scores (S611). Here, N is less than or equal to L.

The answer generation system 100 may identify whether the utility scores of the selected answers are greater than or equal to a first threshold (e.g., 4) (S612).

If the utility scores of the selected answers are greater than or equal to the first threshold as a result of the identification in step 612, the answer generation system 100 may select the answer with the highest critique score from among the top N answers, as a final answer, and provide it to the user terminal (S613).

On the other hand, if the utility scores of the selected answers are less than the first threshold as a result of the identification in step 612, the answer generation system 100 may identify whether the utility scores of the selected answers are less than or equal to a second threshold (e.g., 1) (S614).

If the utility scores of the selected answers are less than or equal to the second threshold as a result of the identification in step 614, the answer generation system 100 may generate an answer based only on the user's query using the LLM model 172 without using the selected answers as the final answer (S615).

On the other hand, if the utility scores of the selected answers are greater than the second threshold and less than the first threshold as a result of the identification in step 614, the answer generation system 100 may re-retrieve documents related to the user query and re-generate answers, based on the re-retrieved documents. At this time, the answer generation system 100 may newly generate a query for re-retrieving documents using the LLM model 172. The newly generated query may be used only for document retrieval. In addition, the document re-retrieval and answer re-generation process may be performed only up to a preset maximum number of times.

As described above, the high-performance RAG-based answer generation method according to an embodiment of the disclosure may improve the performance of retrieval-augmented generation (RAG) by performing evaluation tasks related to the retrieval-augmented generation (RAG), based on a pretrained critique model. In addition, the high-performance RAG-based answer generation method may improve the accuracy of document retrieval and answer generation by improving the performance of the retrieval-augmented generation (RAG), thereby increasing user satisfaction.

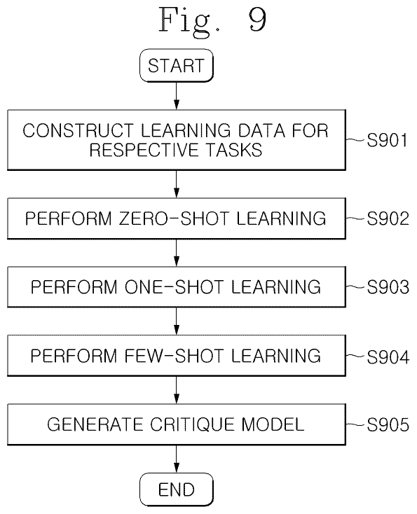

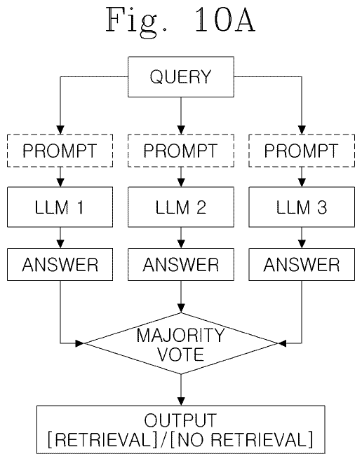

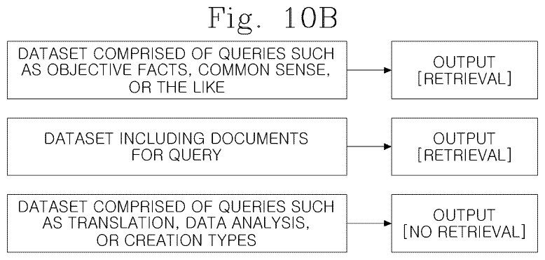

FIG. 9 is a flowchart illustrating a critique model generation method according to an embodiment of the disclosure, and FIGS. 10 to 14 are diagrams illustrating the critique model generation method shown in FIG. 9. The critique model generation method according to the present embodiment may be performed by the high-performance RAG-based answer generation system 100. Although the critique model generation method is illustrated into multiple steps in the illustrated flowchart, at least some of the steps may be performed in a different order, combined with other steps and performed together, omitted, divided into sub-steps and performed, or performed by adding one or more steps that are not illustrated thereto.

Referring to FIGS. 9 to 14, the answer generation system 100 according to the disclosure may construct learning data for respective tasks (S901). Here, the tasks may include first to fourth RAG evaluation tasks.

First, the answer generation system 100 may construct first learning data for training a pretrained language model (PLM) with a first RAG evaluation task.

The first learning data may include input data corresponding to independent variables and output data corresponding to dependent variables. Here, the input data may include query data. The output data may include label data corresponding to the input data. The label data may include [Retrieval] and [No Retrieval].

The answer generation system 100 may generate output data using an LLM labeling method or a data-specific labeling method.

For example, as shown in (a) of FIG. 10, the LLM labeling method may configure a prompt by few-shots to answer whether to refer to the document retrieval results for the query and then receive answers from three LLM models, based on the configured prompt, thereby generating output data by cross-validating them through voting. Meanwhile, as shown in (b) in FIG. 10, the data-specific labeling method may assign [Retrieval] to a dataset including documents (passages) or a dataset including queries that require answer generation based on objective facts, known theories, or common sense, and assign [No Retrieval] to a dataset including queries such as translation, data analysis, or creation types, thereby generating output data.

The answer generation system 100 may construct second learning data for training the pretrained language model (PLM) with a second RAG evaluation task.

The second learning data may include input data corresponding to independent variables and output data corresponding to dependent variables. Here, the input data may include query data and retrieval document data. The output data may include label data corresponding to the input data. The label data may include [Relevant] and [Irrelevant].

The answer generation system 100 may generate output data using an LLM labeling method or a data-specific labeling method.

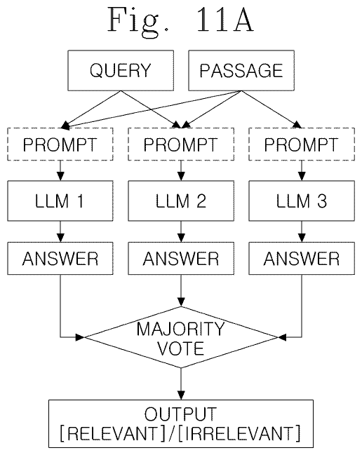

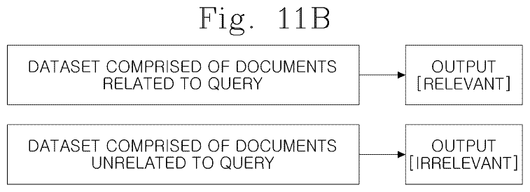

For example, as shown in (a) of FIG. 11, the LLM labeling method may configure a prompt to answer whether there is relevance between a query and a document by inputting the query and the document, and then receive answers from three LLM models, based on the configured prompt, thereby generating output data by cross-validating them through voting. Meanwhile, as shown in (b) of FIG. 11, the data-specific labeling method may assign [Relevant] to a dataset including documents related to the query and assign [Irrelevant] to a dataset including documents unrelated to the query, thereby generating output data.

The answer generation system 100 may construct third learning data for training the pretrained language model (PLM) with a third RAG evaluation task.

The third learning data may include input data corresponding to independent variables and output data corresponding to dependent variables. Here, the input data may include related document data and answer data. The output data may include label data corresponding to the input data. The label data may be composed of [Fully Supported], [Partially Supported], and [Not Supported].

The answer generation system 100 may generate output data using an LLM labeling method or a data-specific labeling method.

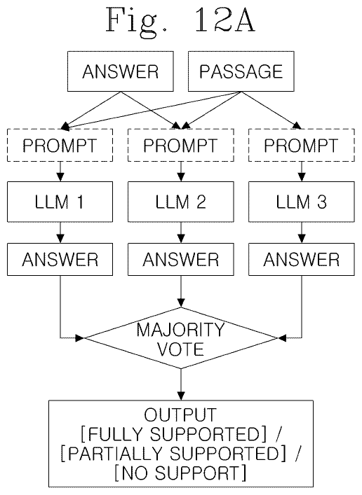

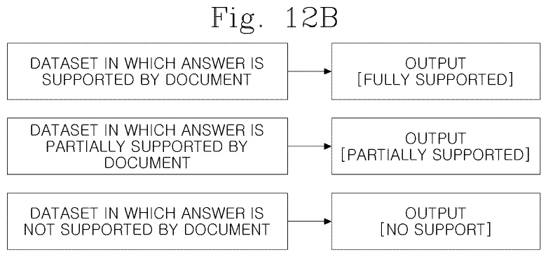

For example, as shown in (a) of FIG. 12, the LLM labeling method may configure a prompt to answer about the groundedness between an answer and a document by inputting the answer and the document and then receive answers from three LLM models, based on the prompt, thereby generating output data by cross-validating them. Meanwhile, as shown in (b) of FIG. 12, the data-specific labeling method may assign [Fully Supported] to a dataset in which the answer is supported by a document, [Partially Supported] to a dataset in which the answer is partially supported by a document, and [Not Supported] to a dataset in which the answer is not supported by a document, thereby generating output data.

The answer generation system 100 may construct fourth learning data for training the pretrained language model (PLM) with a fourth RAG evaluation task.

The fourth learning data may include input data corresponding to independent variables and output data corresponding to dependent variables. Here, the input data may include query data and answer data. The output data may include label data corresponding to the input data. The label data may include [Utility 1], [Utility 2], [Utility 3], [Utility 4], and [Utility 5].

The answer generation system 100 may generate output data using an LLM labeling method or a data-specific labeling method.

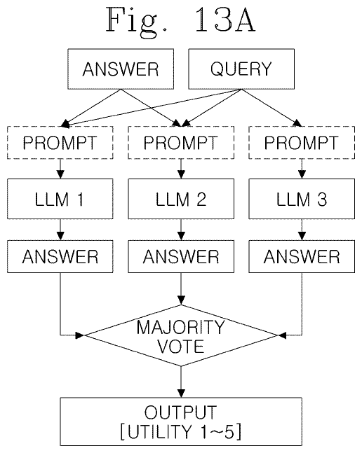

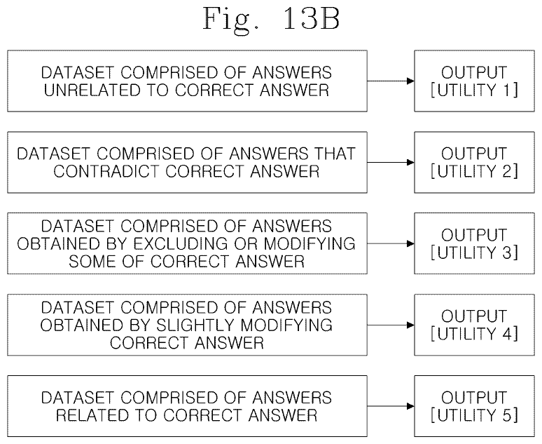

For example, as shown in (a) of FIG. 13, the LLM labeling method may configure a prompt to answer about the groundedness between an answer and a query by inputting the answer and the query and then receive answers from three LLM models, based on the prompt, thereby generating output data by cross-validating them. Meanwhile, as shown in (b) of FIG. 13, the data-specific labeling method may assign [Utility 1] to a dataset including answers that are unrelated to the correct answer, assign [Utility 2] to a dataset including answers that contradict the correct answer, assign [Utility 3] to a dataset including answers obtained by excluding or modifying some of the correct answer, assign [Utility 4] to a dataset including answers obtained by slightly modifying the correct answer, and assign [Utility 5] to a dataset including answers related to the correct answer, thereby generating output data.

The answer generation system 100 may fine-tune a pretrained language model (PLM), based on pre-built task-specific learning data. The LLAMA model may be used as the pretrained language model (PLM), but the disclosure is not necessarily limited thereto.

For example, the answer generation system 100 may fine-tune a pretrained language model (PLM) using the coarse-to-fine learning method. At this time, the answer generation system 100 may perform coarse-to-fine learning on respective tasks.

Coarse-to-fine learning is a method of learning from a wide range (i.e., a general question) to a narrow range (i.e., a question with characteristics). In other words, the coarse-to-fine learning is a method of sequentially performing zero-shot learning, one-shot learning, and few-shot learning. The reason for sequential learning is to resolve vulnerabilities discovered during learning.

First, the answer generation system 100 may perform zero-shot learning on the pretrained language model (PLM) (S902). Here, zero-shot learning is a learning method that enables the model to recognize a new class that was not seen during the learning process.

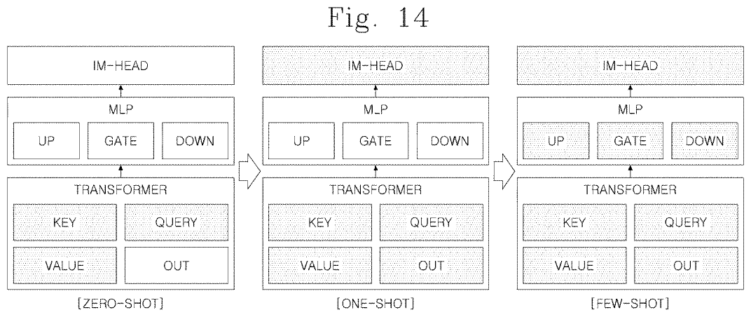

For example, as illustrated in FIG. 14, the answer generation system 100 may perform zero-shot learning on the pretrained language model (PLM) to update the key, query, and value parameters of a transformer layer.

When the zero-shot learning is completed, the answer generation system 100 may perform one-shot learning on the pretrained language model (PLM) (S903). Here, one-shot learning is a learning method that enables the model to recognize a class when only one example is provided for each class.

The answer generation system 100 may perform one-shot learning by adding a guide prompt that suggests a solution to a problem in which an error occurs in a zero-shot environment to the pretrained language model (PLM).

For example, as illustrated in FIG. 14, the answer generation system 100 may perform one-shot learning on the pretrained language model (PLM) to update the parameters of a transformer layer and an im-head layer.

When the one-shot learning is completed, the answer generation system 100 may perform few-shot learning on the pretrained language model (PLM) (S904). Here, few-shot learning is a method of quickly learning a new task or class using only a very small amount of data.

For example, as illustrated in FIG. 14, the answer generation system 100 may perform few-shot learning on the pretrained language model (PLM) to update the parameters of a transformer layer, an intermediate layer (MLP layer), and an im-head layer.

The answer generation system 100 may sequentially perform zero-shot learning, one-shot learning, and few-shot learning on the pretrained language model (PLM) to generate a critique model (S905). The critique model may perform the first to fourth RAG evaluation tasks.

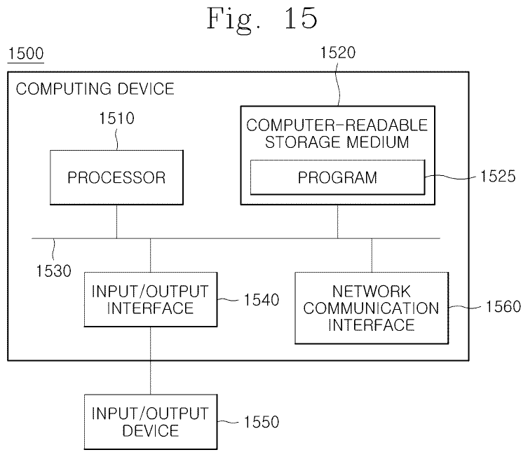

FIG. 15 is a block diagram of a computing device according to an embodiment of the disclosure.

Referring to FIG. 15, a computing device 1500 according to an embodiment of the disclosure may include at least one processor 1510, a computer-readable storage medium 1520, and a communication bus 1530. The computing device 1500 may implement the high-performance RAG-based answer generation system 100 described above or the components 110 to 170 constituting the system.

The processor 1510 may cause the computing device 1500 to operate according to the exemplary embodiments mentioned above. For example, the processor 1510 may execute one or more programs 1525 stored on a computer-readable storage medium 1520. The one or more programs may include one or more computer-executable instructions, and the computer-executable instructions, when executed by the processor 1510, may be configured to cause the computing device 1500 to perform operations according to the exemplary embodiments.

The computer-readable storage medium 1520 is configured to store computer-executable instructions, program code, program data, and/or other suitable forms of information. The program 1525 stored on the computer-readable storage medium 1520 includes a set of instructions executable by the processor 1510. In an embodiment, the computer-readable storage medium 1520 may be memory (volatile memory, such as random-access memory, nonvolatile memory, or a suitable combination thereof), one or more magnetic disk storage devices, optical disk storage devices, flash memory devices, another type of storage medium capable of being accessed by the computing device 1500 and storing desired information, or a suitable combination thereof.

The communication bus 1530 interconnects various components of the computing device 1500, including the processor 1510 and the computer-readable storage medium 1520.

The computing device 1500 may also include one or more input/output interfaces 1540 that provide interfaces for one or more input/output devices 1550, and one or more network communication interfaces 1560. The input/output interfaces 1540 and the network communication interfaces 1560 are connected to the communication bus 1530.

The input/output device 1550 may be connected to other components of the computing device 1500 via the input/output interface 1540. For example, the input/output devices 1550 may include input devices such as a pointing device (mouse, trackpad, etc.), a keyboard, a touch input device (touchpad, touchscreen, etc.), a voice or sound input device, various types of sensor devices and/or photographing devices, and/or output devices such as a display device, a printer, a speaker, and/or a network card. The exemplary input/output device 1550 may be included inside the computing device 1500 as a component that constitutes the computing device 1500, or may be configured as a separate device distinct from the computing device 1500 and then connected to the computing device 1500.

The effects of the high-performance RAG-based answer generation method and the system therefor according to embodiments of the disclosure will be described below.

According to at least one of the embodiments of the disclosure, there is an advantage in which the performance of retrieval-augmented generation (RAG) may be improved by performing evaluation tasks related to the retrieval-augmented generation (RAG), based on a pretrained critique model.

In addition, according to at least one of the embodiments of the disclosure, there is an advantage in which the accuracy of document retrieval and answer generation may be improved by enhancing the performance of retrieval-augmented generation (RAG), thereby increasing user satisfaction.

However, the effects obtainable from the high-performance RAG-based answer generation method and the system therefor according to the embodiments of the disclosure are not limited to those mentioned above, and other effects that are not mentioned will be clearly understood by those skilled in the art to which the disclosure belongs from the description below.

The disclosure above may be implemented as a computer-readable code on a medium in which a program is recorded. The computer-readable medium may be a medium that continuously stores a computer-executable program or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, ROMS, RAMS, flash memories, and the like, which are configured to store program instructions. In addition, examples of other media may include recording media or storage media managed by app stores that distribute applications, or sites or servers that supply or distribute various software. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

What is claimed is:

1. A method for generating an answer based on retrieval-augmented generation (RAG) performed by a computing device, the method comprising:
acquiring a query;
performing a first evaluation task based on the query using a pre-trained critique model;
retrieving documents related to the query based on a result of the first evaluation task;
performing a second evaluation task based on the query and the retrieved documents using the critique model; and
generating one or more answers, based on the query and one or more related documents, using a large language model (LIM) according to a result of the second evaluation task.

2. The method for generating an answer of claim 1,
further comprising generating an answer corresponding to the query, based only on the query, using the LLM model according to a result of the second evaluation task.

3. The method for generating an answer of claim 1,
wherein the first evaluation task is a task for determining whether to generate an answer with reference to a document retrieval result for the query or to generate an answer without referring to the document retrieval result.

4. The method for generating an answer of claim 1,
wherein the critique model, when performing the first evaluation task, determines whether to refer to a document retrieval result based on the query and outputs one of a [Retrieval] token and a [No Retrieval] token based on the determination result.

5. The method for generating an answer of claim 1,
further comprising resorting ranks of the retrieved documents.

6. The method for generating an answer of claim 1,
wherein the second evaluation task is a task for evaluating relevance between the query and the retrieved documents.

7. The method for generating an answer of claim 1,
wherein the critique model, when performing the second evaluation task, determines relevance between the query and the retrieved documents and assigns one of a [Relevant] token and an [Irrelevant] token to the retrieved documents based on the determination result.

8. The method for generating an answer of claim 1,
further comprising performing a third evaluation task by inputting the one or more related documents and the one or more answers into the critique model.

9. The method for generating an answer of claim 8,
wherein the third evaluation task is a task for evaluating groundedness between the related documents and the answers.

10. The method for generating an answer of claim 8,
wherein the critique model, when performing the third evaluation task, determines groundedness between the related documents and the answers and assigns one of a [Fully Supported] token, a [Partially Supported] token, and a [Not Supported] token to the answers based on the determination result.

11. The method for generating an answer of claim 1,
further comprising performing a fourth evaluation task by inputting the query and the one or more answers into the critique model.

12. The method for generating an answer of claim 11,
wherein the fourth evaluation task is a task for evaluating a utility score between the query and the answers.

13. The method for generating an answer of claim 11,
wherein the critique model, when performing the fourth evaluation task, determines a utility score between the query and the answers and assigns one of a [Utility 1] token to a [Utility 5] token to the answers based on the determination result.

14. The method for generating an answer of claim 1, further comprising:
calculating critique scores for the one or more answers; and
determining a final answer, based on the calculated critique scores.

15. The method for generating an answer of claim 1,
wherein the critique model is generated by fine-tuning a pre-trained language model (PLM), based on learning data for respective tasks.

16. The method for generating an answer of claim 15,
wherein a method of fine-tuning the PLM model is a coarse-to-fine learning method.

17. The method for generating an answer of claim 16,
wherein the coarse-to-fine learning method is a method of sequentially performing zero-shot learning, one-shot learning, and few-shot learning.

18. A device comprising:
one or more processors configured to execute a plurality of operations for generating an answer based on retrieval-augmented generation (RAG); and
one or more memories configured to store a plurality of instructions for executing the plurality of operations,
wherein the plurality of operations comprise:
acquiring a query;
performing a first evaluation task based on the query using a pre-trained critique model;
retrieving documents related to the query based on a result of the first evaluation task;
performing a second evaluation task based on the query and the retrieved documents using the critique model; and
generating one or more answers, based on the query and one or more related documents, using a large language model (LIM) according to a result of the second evaluation task.

19. A computer-readable storage medium storing one or more programs for generating an answer corresponding to a query by one or more processors of a computing device, the one or more programs comprising instructions for:
acquiring a query;
performing a first evaluation task based on the query using a pre-trained critique model;
retrieving documents related to the query based on a result of the first evaluation task;
performing a second evaluation task based on the query and the retrieved documents using the critique model; and
generating one or more answers, based on the query and one or more related documents, using a large language model (LIM) according to a result of the second evaluation task.
